(19) United States
(12) Patent Application Publication
(10) Pub. No.: US 2020/0392754 A1
(43) Pub. Date: Dec. 17, 2020

(54) MANUAL CONTROL DEVICE OF THE OPENING AND CLOSING OF THE LOCK OF A DOOR OR WINDOW

(71) Applicant: Pascal LECLERCQ, Brescia (IT)

(72) Inventor: Pascal LECLERCQ, Brescia (IT)

(21) Appl. No.: 16/761,481

(22) PCT Filed: Nov. 3, 2017
(86) PCT No.: PCT/IT2017/000240

§ 371 Date: May 4, 2020

(51) Int. Cl. E05B 3/04

(52) U.S. Cl. CPC E05B 3/04; E05B 2003/006

(57) ABSTRACT

A manual device opening and closing a lock of a door or window has a control rod; a supporting body having a cavity for the control rod; a manual gripping member having a housing; and an adapter interconnecting the gripping member and the supporting body. The adapter arranged in the housing provided in said gripping member and in turn having a housing for the supporting body. An elastic axial extraction block of the supporting body from the control rod. A block between the adapter element and the supporting body and between the adapter element and the manual gripping member. A supporting plate of the supporting body fixed to the door or window and has a hole for an end of the supporting body to rotatably engage and extends outside the adapter element. A braking and stabilizing member for inserting of the control rod in the cavity of the supporting body.

### CROSS REFERENCE TO RELATED APPLICATION

This is a U.S. National Phase Application under 35 U.S.C. § 371 of International Patent Application No. PCT/IT2017/000240, filed Nov. 3, 2017. The entire contents of which are hereby incorporated by reference.

### FIELD OF THE INVENTION

The present invention relates to a manual control device of the opening and closing of the lock of a door or window, particularly for doors and/or windows.

A known manual control device comprises a manual gripping member, for example a handle, a supporting body longitudinally hollow adapted to support the manual gripping member, a plate fixable to the door or window for supporting the supporting body, and a control rod or panel of an opening and closing mechanism of the lock, arranged through a hole of the plate and coaxially inserted in the supporting body.

### SUMMARY OF THE INVENTION

In use the manual gripping member, the supporting body and the control rod are solid in rotation for activating the lock.

One of the drawbacks that can occur during the assembly step consists in the fact that the penetrating portion of the control rod in the cavity of the supporting body is not controllable by the assembler with a great degree of precision.

If the entity of the penetration is excessive the control element can project from the side of the supporting body opposite the introduction side and can interfere with the gripping member, thus preventing the fixing with the supporting body.

These control devices present other drawbacks.

For example, the pre-assembling of the manual control device, owing to the fact it requires specific tools, can be delicate and not immediately achievable, at least each time the necessary tools are not immediately available.

Sometimes, in order to fit some components to one another, mere human force is not sufficient and it becomes necessary to avail of tools that require a source of electrical energy in order to function.

In this case the installer must be provided with the device already pre-assembled for the installation on the door or window.

The installer therefore has a pre-assembled finished product to hand, which leaves no space for customizing the finishings so as to satisfy the requirements of the final customer.

The technical task of the present invention is, therefore, to provide a manual control device of the opening and closing of the lock of a door or window which obviates the above-described technical drawbacks of the priormi.

The technical task of the present invention is, therefore, to realize a manual control device of the opening and closing of the lock of a door or window which can be assembled simply and precisely.

A further aim of the invention is to realize a manual control device of the opening and closing of the lock of a door or window configured in such a way as to broaden the possibility of choice with regard to the aesthetic appearance of the product.

A further aim of the invention is to realize a manual control device of the opening and closing of the lock of a door or window of the type described in the foregoing, which has universally usable components in various possible applications.

The technical task, as well as these and other objects according to the present invention, are attained by a manual control device of the opening and closing of the lock of a door or window, characterized in that it comprises:
a control rod;
a supporting body having a cavity in which said control rod is arranged;
a manual gripping member having a housing;
an adapter element for interconnection between said manual gripping member and said supporting body, said adapter element being arranged in said housing provided in said gripping member and in turn having a housing in which said supporting body is arranged;
at least one elastic blocking member of an axial extraction of said supporting body from said control rod;
blocking means between said adapter element and said supporting body;
blocking means between said adapter element and said manual gripping member;
a supporting plate of said supporting body fixable to said door or window and provided with a hole in which an end of said supporting body is rotatably engaged, which extends outside said adapter element;
a braking and stabilizing member of the inserting position of the control rod in said cavity of said supporting body, said supporting body having a first housing wherein at least one elastic member is arranged and at least one second housing wherein said braking member is arranged.

The control device is extremely advantageous because it enables rapidly obtaining a correct and precise assembly of the components without the assembly necessarily having a particular ability. Said blocking means between said adapter element and said manual gripping member preferably comprises at least one anti-extraction grub screw preventing the extraction of the manual gripping member from said adapter element, said anti-extraction grub screw being engaged in a hole delimited by matching longitudinal grooves of the external surface of said adapter element and the internal surface of said housing provided in said gripping member.

Preferably, said blocking means between said adapter element and said manual gripping member further comprises at least one anti-rotation organ which prevents relative rotation between said manual gripping member and said adapter element, said anti-rotation organ being formed by a longitudinal protrusion of the external surface of said adapter element engaged in a complementarily-shaped recess formed on the internal surface of said housing provided in said gripping member or vice versa.

Said blocking means between said adapter element and said supporting body preferably comprise an open ring arranged in matching perimeter grooves of said adapter element and said supporting body.

Said blocking means between said adapter element and said supporting body preferably comprises at least one anti-rotation organ which prevents the relative rotation between said supporting body and said adapter element, said anti-rotation organ being formed by a longitudinal protrusion of the internal surface of said adapter element engaged in a complementarily-shaped recess formed on the external surface of said supporting body or vice versa.

The use of the blocking means that can be activated manually advantageously enables the assembly of the control device directly in the place of installation of the door or window.

The installer in this case can also receive the rough components and customize them with the finishings requested by the customer before proceeding to assembly.

### BRIEF DESCRIPTION OF THE DRAWINGS

Further characteristics and advantages of the invention will more fully emerge from the description of a preferred but not exclusive embodiment of the manual control device of the opening and closing of the lock of a door or window according to the invention, illustrated by way of non-limiting example in the accompanying figures of the drawings, in which:

FIG. 1 is an exploded view of the manual control device;

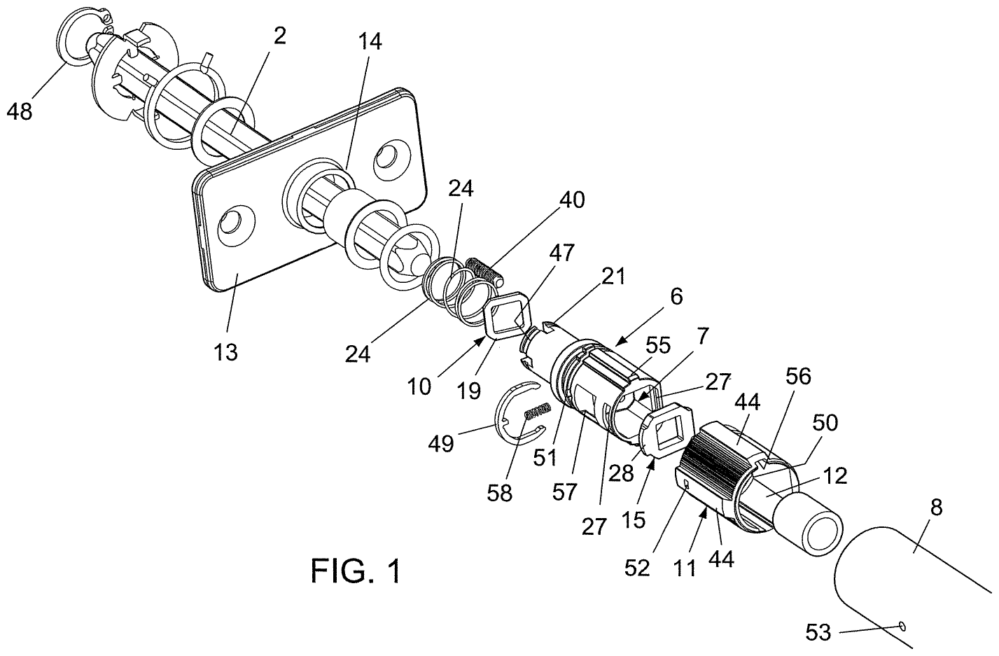

FIG. 2A shows the assembled device of FIG. 1 in longitudinal section; FIG. 2B is a larger-scale view of a detail of FIG. 2A;

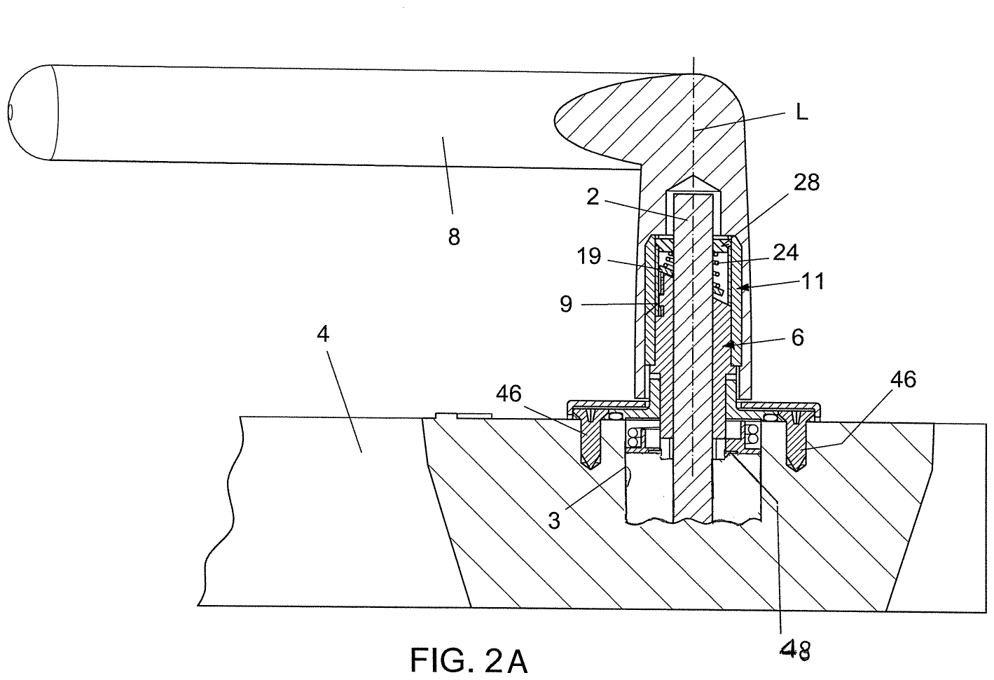

FIG. 3 illustrates the assembled device of FIG. 1 in transversal section at the height of the housing afforded in the gripping member.

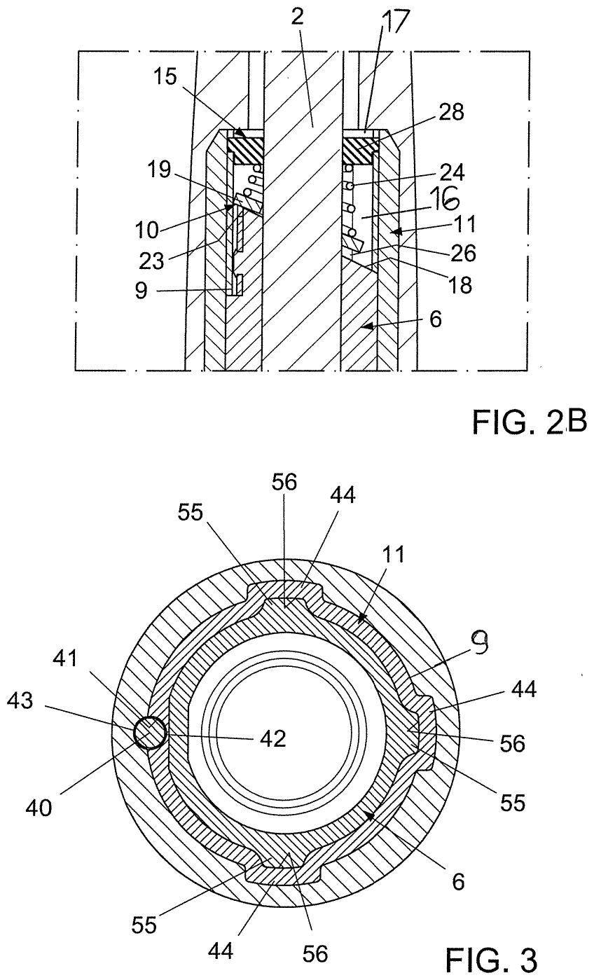

### DETAILED DESCRIPTION OF THE DRAWINGS

The control device 1 comprises a control rod 2 preferably having a square section for controlling a lock (not illustrated).

The control rod 2 projects from a transversal hole 3 of the door or window 4 where it interacts with the lock.

The control device 1 further has a longitudinal supporting body 6 having a cavity 7, in particular a through cavity in a longitudinal direction, in which the control rod 2 is arranged, a manual gripping member 8 having a housing 9, one or more elastic blocking elements 10 of the axial extraction of said supporting body 6 from the control rod 2, and a longitudinal adapter element 11 for interconnection between the manual gripping member 8 and the supporting body 6.

The manual gripping member 8 can be as shown in the form of a handle or also a knob. The elastic blocking member 10 preferably comprises a leaf spring 19.

The longitudinal cavity 7 of the supporting body 6 has a shape coupling with the control rod 2. The adapter element 11 is arranged in said housing 9 provided in said gripping member 8 and in turn has a housing 12 in which the supporting body 6 is arranged.

The housing 12 fashioned in the adapter element 11 is configured as a through cavity in a longitudinal direction.

The adapter element 11, as will emerge in greater detail in the following, has a shape that couples externally to the housing 9 provided in the gripping member 8 and that couples internally to said supporting body 6.

The control device 1 further comprises blocking means between the adapter element 11 and the supporting body 6, blocking means between the adapter element 11 and the manual gripping member 8, and a supporting plate 13 of the supporting body 6 fixable to the door or window and provided with a hole 14 in which an end 21 of the supporting body 6 is rotatably engaged, which extends outside the adapter element 11.

The supporting plate 13 of the supporting body 6 is fixed to the wall of the door or window 4, by means of screws 46, for example.

The external end 21 of the supporting body 6 has an external perimeter groove 47 in which an elastic ring 48 is arranged to prevent extraction of the supporting body 6 from the hole 14 of the supporting plate 13.

Advantageously the control device 1 also comprises a braking and stabilizing member 15 of the correct inserting position of the control rod 2 in the supporting body 6.

The supporting body 6 has a first housing 16 communicating with the cavity 7 in which the elastic blocking member 10 and a second housing 17 communicating with the cavity 7 in which the braking member 15 is arranged.

The second housing 17 is arranged, with respect to the first housing 16, in a distal position from the external end 21 of the supporting body 6.

The first housing 16 is delimited by a wall 18 that is flat and inclined with respect to the axis of the supporting body 6.

The leaf spring 19 is maintained in contact with the wall 18 of the housing body 16 in contrast with and by action of an elastic element 24, for example a helix spring coaxial to the control rod 2, interposed between the leaf spring 19 and the braking member 15.

The elastic member 24 constrains a side of the perimeter edge of the leaf spring 19 resting along the side 23 of the perimeter edge of the wall 18 of the first housing 16 distal from the external end of the supporting body 6.

A free space 26 is present between the leaf spring 19 and the wall 18 of the first housing 16, because of the different lying plane of the leaf spring with respect to the wall 18 of the first housing 16.

The constraint between the leaf spring and the side 23 of the perimeter edge of the wall 18 of the first housing 16 functions as a rotation fulcrum for the leaf spring 19 which can flex in the free space 26.

The leaf spring 19 can oscillate between a blocked condition of the control rod 2 in which the lying plane forms the minimum angle with the wall 18 of the first housing 16 and an unblocked condition of the control rod 2 in which the lying plane forms the maximum angle with the wall 18 of the first housing 16.

In this matter, the supporting body 6 has a window 57 for accessing the leaf spring 19 using a tool with which the leaf spring 19 can be drawn from the blocked condition into the unblocked condition in order to extract the control rod 2.

The braking member 15 is fixed in the second housing 17 and in particular has perimeter fins 28 jointed in through openings 27 passing through the thickness of the lateral wall of the supporting body 6.

The braking member 15 can preferably be made of rubber, for example made of silicone rubber, or another elastically-yielding material.

The braking member 15 has an axial symmetric configuration and has an axial hole in which the control rod 2 is slidingly insertable by friction.

The braking member 15 can also be made of a closed-cell expanded material.

The blocking means between the adapter element 11 and the manual gripping member 8 includes two independent systems, one for preventing reciprocal rotation and one for preventing reciprocal axial extraction.

The blocking means between the adapter element 11 and the manual gripping member 8 for blocking the reciprocal extraction comprises at least one grub screw 40 engaged in a hole 41 delimited by matching longitudinal grooves 42, 43 of the external surface of said adapter element 11 and the internal surface of the housing 9 provided in the gripping member 8.

The blocking means between the adapter element 11 and the manual gripping member 8 for blocking the reciprocal rotation comprises at least one anti-rotation organ formed by a longitudinal protrusion 44 of the external surface of the adapter element 11 engaged in a recess 45 having a complementary shape formed on the internal surface of the housing 9 provided in the manual gripping member 8 or viceversa.

Also the blocking means between the adapter element 11 and the supporting body 6 includes two independent systems, one for preventing reciprocal rotation and one for preventing reciprocal axial extraction.

The blocking means between said adapter element 11 and said supporting body 6 for preventing reciprocal extraction comprises an open ring 49 arranged in matching perimeter grooves 50, 51 of said adapter element 11 and said supporting body 6.

The open ring 49 is radially mobile in contrast to and by action of a spring 58.

The open ring 49 is accessible from outside via two superposed through holes, and in particular a through hole 52 through the thickness of the spacer element 11 and a through hole 53 through the wall thickness of the gripping member 8.

Using the pressure of the tip of a simple tool inserted through the through holes 52, 53, the open ring 49 can be reversibly brought from a blocked configuration in which it is engaged in both the matching perimeter grooves 50, 51 of the adapter element 11 and the supporting body 6, to an unblocked position in which it is exclusively engaged in the perimeter groove 51 of the supporting body 6.

The blocking means between the adapter element 11 and the supporting body 6 for preventing the reciprocal rotation comprises at least one anti-rotation organ which prevents the relative rotation between the supporting body 6 and the adapter element 11 and is formed by a longitudinal protrusion 55 of the external surface of the supporting body 6 engaged in a recess 56 having a complementary shape formed on the internal surface of the adapter element 11, or vice versa.

The blocking means, both those for the blocking between the gripping member 8 and the adapter 11 and those for the blocking between the supporting body 6 and the adapter 11 being activatable by hand, enable carrying out the assembly of the control device directly in the place of installation, affording the installer receiving the rough components the opportunity of carrying out the customized finishings.

The error-free assembly of the control device is also facilitated by the fact that the matching surfaces between the adapter element 11 and the gripping member 8 and between the adapter element 11 and the supporting body 6 are asymmetric with respect to the axis L according to which the gripping member 8 and the supporting body 6 are engaged to one another so that the engagement is enabled for a single angular orientation between the adapter element 11 and the supporting body 6 and between the adapter element 11 and the gripping member 8.

The assembly of the control device takes place in the following way. First the control rod 2 is inserted in the cavity 7 of the supporting body 6.

The control rod 2 initially engages the leaf spring 19 which, while flexing by effect of the interaction with the control rod 2, is orientated in such a way as to offer the control rod 2 a free section that is sufficient for passage.

The end of the control rod 2, once the leaf spring has been crossed, is progressively introduced in the hole of the braking member 15 by which it is braked and stabilized in the correct position before the final blocking carried out by the leafspring.

Thereafter the supporting body 6 is fixed in the adapter element 11 by the above-mentioned blocking means and lastly the adapter element 11 is fixed in the housing of the gripping member 8 by the above-mentioned blocking means.

The manual control device of the opening and closing of the lock of a door or window as conceived herein is susceptible to numerous modifications and variants, all falling within the scope of the inventive concept; furthermore, all the details are replaceable by technically equivalent elements.

In practice the materials used, as well as the dimensions, can be any according to the needs and the state of the art.

1. A manual control device of the opening and closing of the lock of a door or window, comprises:
a control rod;
a supporting body having a cavity in which said control rod is arranged;
a manual gripping member having a housing;
an adapter element for interconnection between said manual gripping member and said supporting body, said adapter element being arranged in said housing provided in said gripping member and in turn having a housing in which said supporting body is arranged;
at least one elastic blocking element of an axial extraction of said supporting body from said control rod;
blocking means between said adapter element and said supporting body;
blocking means between said adapter element and said manual gripping member;
a supporting plate of said supporting body fixable to said door or window and provided with a hole in which an end of said supporting body is rotatably engaged, which extends outside said adapter element;
a braking and stabilizing member of the inserting position of said control rod in said cavity of said supporting body, said supporting body having a first housing wherein said at least one elastic member is arranged and at least one second housing wherein said braking member is arranged.

2. The manual control device of the opening and closing of the lock of a door or window, according to claim 1, characterized in that said adapter element has a shape that couples externally to said housing provided in said gripping member and that couples internally to said supporting body.

3. The manual control device of the opening and closing of the lock of a door or window, according to claim 1, characterized in that said supporting body has a longitudinal conformation and said cavity in which said control rod is arranged is a through cavity in a longitudinal direction.

4. The manual control device of the opening and closing of the lock of a door or window, according to claim 1, characterized in that said adapter element has a longitudinal conformation and said housing in which said supporting body (6) is arranged is formed by a through cavity in a longitudinal direction.

5. The manual control device of the opening and closing of the lock of a door or window, according to claim 1, characterized in that said braking member is made of rubber or a closed-cell expanded material.

6. The manual control device of the opening and closing of the lock of a door or window, according to claim 5, characterized in that said braking member has a hole in which said control rod is engageable.

7. The manual control device of the opening and closing of the lock of a door or window, according to claim 1, characterized in that said blocking means between said adapter element and said manual gripping member comprises at least one anti-extraction grub screw preventing the extraction of the manual gripping member from said adapter element, said anti-extraction grub screw being engaged in a hole delimited by matching longitudinal grooves of the external surface of said adapter element and the internal surface of said housing provided in said gripping member.

8. The manual control device of the opening and closing of the lock of a door or window, according to claim 1, characterized in that said blocking means between said adapter element and said manual gripping member comprises at least one anti-rotation organ which prevents relative rotation between said manual gripping member and said adapter element, said anti-rotation organ being formed by a longitudinal protrusion of the external surface of said adapter element engaged in a complementarily-shaped recess formed on the internal surface of said housing provided in said gripping member or vice versa.

9. The manual control device of the opening and closing of the lock of a door or window, according to claim 1, characterized in that said blocking means between said adapter element and said supporting body comprises an open ring arranged in matching perimeter grooves of said adapter element and said supporting body.

10. The manual control device of the opening and closing of the lock of a door or window, according to claim 1, characterized in that said blocking means between said adapter element and said supporting body comprises at least one anti-rotation organ which prevents the relative rotation between said supporting body and said adapter element, said anti-rotation organ being formed by a longitudinal protrusion of the internal surface of said adapter element engaged in a complementarily-shaped recess formed on the external surface of said supporting body or vice versa.

11. The manual control device of the opening and closing of the lock of a door or window, according to claim 1, characterized in that the matching surfaces between said adapter element and said gripping member and between said adapter element and said supporting body are asymmetrical with respect to a coupling axis between said adapter element, said gripping member and said supporting body.
